(19) United States
(12) Patent Application Publication
(10) Pub. No.: US 2006/0259759 A1
(43) Pub. Date: Nov. 16, 2006

(54) Method and apparatus for securely extending a protected network through secure intermediation of AAA information

(76) Inventors: Fabio Maino, Palo Alto, CA (US); Michael Fine, San Francisco, CA (US); Irene Kuffel, Napa, CA (US); Wilson Kok, San Jose, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/130,654

(22) Filed: May 16, 2005

(51) Int. Cl. H04L 9/00

(52) U.S. Cl. 713/151

(57) ABSTRACT

A method of securely extending a protected network through secure relay of AAA information, when an isolated device lacks Layer 3 connectivity to an AAA infrastructure of the protected network, comprises receiving a first authentication message, from an isolated first network device, wherein the first authentication message is encapsulated in a first Layer 2 message, wherein the first authentication message seeks to authenticate a second network device using an authentication server, and wherein the second network device and the authentication server are within a protected network; extracting the first authentication message from the first Layer 2 message; forming a packet that includes the first authentication message; sending the packet with the extracted authentication message over a Layer 3 link to the authentication server, without modifying the extracted authentication message. Thus a network node within a protected network can relay AAA requests and responses between an isolated AAA client, encapsulated in Layer 2 messages, and an AAA server, in Layer 3 messages.

### FIELD OF THE INVENTION

The present invention generally relates to computer network communication security and network management. The invention relates more specifically to methods and apparatus relating to secure network fabric building, including secure device admission, device authentication, and network authentication.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Authentication, Authorization, and Accounting (AAA) client/server protocols are used in computer networks to authenticate users or devices, to authorize the use of resources by users or devices, and to generate and store accounting information of how the users or devices utilize the resources. Under AAA protocols, authentication, authorization and configuration information is typically exchanged between AAA clients and AAA servers in OSI Layer 3 protocol messages that are transported over wired or wireless networks. Typically, the clients are responsible for receiving information from a user or device, passing the information to an AAA server or servers, and acting on the response that is returned. The AAA servers are responsible for receiving requests, authenticating the user or device, and then returning all configuration information necessary for the client to deliver service to the user or device.

Recently AAA protocols have been used to provide authentication, access control and auditing for network devices that wish to join a secure network, such as Fibre Channel switches that are willing to join a secure Fibre Channel switch fabric, or Ethernet switches or routers that are willing to authenticate devices that are coupled to neighbor routers or switches. No problems arise in providing AAA services to two devices that are trying to mutually authenticate when both devices can access an AAA server or other infrastructure through Layer 3 connectivity, for example, using Internet Protocol (IP) packets. However, significant difficulties arise in using AAA protocols to securely deploy and communicate with an isolated network device that is connected to an established network element but does not have Layer 3 connectivity and cannot obtain an IP address.

These problems arise, for example, when a newly deployed device only has actual or virtual Layer 2 connectivity (e.g., with Ethernet) to other network elements, and in other configurations when a first one of the devices has IP access to the AAA server and the second does not. Such configurations are quite common, in wireless deployments wherein the Access Point has full IP connectivity to the AAA infrastructure and the wireless supplicant does not. For example, a first network device may be part of the authenticated network already, and the second device may be an isolated device that is attempting to join the network.

What is needed is a way to enable such an isolated device to obtain AAA services, so that it can authenticate the access point to a network before joining the network. There is a specific need for a way to provide secure AAA communication between a device that is connected by a Layer 2 link to an untrusted access point to a Layer 3 network, and a AAA server in that Layer 3 network.

One past approach that attempts to address the disadvantage of using AAA protocols to securely deploy new clients is described in co-pending U.S. patent application no. NNN, filed Mar. 17, 2005, “Method and Apparatus to Secure AAA Protocol Messages,” of Fabio Maino et al., Attorney Docket No. 50325-0971.

One previous attempt to securely extend protected networks is based on the use of the 802.1x authentication protocol. While this approach allows the access device to authenticate or authorize properly the isolated device that wants to join the protected network, no provisioning of authentication or authorization information to the isolated device occurs, and therefore the isolated device can be fooled into joining the wrong protected network. Another attempt to provide mechanisms to securely extend protected network involves use of Microsoft Challenge-Authentication Protocol (MS-CHAPv2), defined in RFC 2759. This approach provides, to a wireless supplicant willing to join a protected network via an access point, a weak authentication of the AAA infrastructure. However, there is no provision for explicit authentication of the access point, or for distribution of authorization information to the wireless supplicant.

AAA protocols include the Terminal Access Controller Access Control System (TACACS) protocol and Remote Authentication Dial-In User Service (RADIUS) protocol. The TACACS protocol is a User Datagram Protocol (UDP)-based, access-control protocol described in Request for Comments (RFC) 1492 published by the Internet Engineering Task Force (IETF) in July 1993. RADIUS is a widely used AAA protocol that also uses UDP for communications between RADIUS clients and RADIUS servers. RADIUS is defined in RFC 2865, published by IETF in June 2000.

RADIUS clients and servers are identified by their IP addresses. RADIUS messages are secured by binding a secret to a client IP address. The secret is shared between the client and the server and is never transmitted over the network. The RADIUS protocol employs the shared secret to compute a Message Integrity Check value that is included in RADIUS requests and responses so that the receiver can verify the origin and integrity of a given message.

Both TACACS and RADIUS servers must store client information. The client information includes at least the IP addresses of the client and, in the case of RADIUS, the shared secret. Both TACACS and RADIUS share the disadvantages mentioned above—they do not scale to networks that may potentially include a large number of clients, and there are significant security risks in using these protocols to deploy new clients that have not yet been assigned IP addresses.

Based on the foregoing, there is a clear need for providing secure network fabric building that overcomes the disadvantages outlined above.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a high-level overview of a system in which an embodiment may be implemented;

FIG. 2A is a ladder message diagram showing one example embodiment of a method of communicating authentication information;

FIG. 2B is a ladder message diagram showing further steps in the method of FIG. 2A;

FIG. 3 is a flow diagram showing a high-level view of one embodiment of a method of communicating authentication information;

FIG. 4 is a block diagram of an EAPOL policy relay message;

FIG. 5 is a block diagram of a computer system with which an embodiment can be implemented.

### DETAILED DESCRIPTION

A method and apparatus for securely building a network fabric are described. In this context, “securely building a network fabric” generally refers to securely admitting a new device to a network fabric, and authenticating the new isolated device to the fabric, as well as providing the isolated device a way to authenticate the network it is joining, and to securely retrieve authorization information. Using the techniques herein, a protected network may be extended to include new devices in a secure manner. Through secure intermediation of AAA services, an isolated device can securely retrieve authentication and authorization information from the protected network that the isolated device is attempting to join.

This techniques herein can be used to securely extend a protected network, enabling the secure exchange of authentication, authorization, and accounting information between the isolated device and the AAA infrastructure of the protected network. The same capability can be used to merge two protected networks that have been deployed as two independent authentication and authorization domains. If a trust relationship exists between the two AAA domains, the approach herein allows the two devices used to connect the protected networks to securely obtain AAA services from the other domain.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Furthermore, in the following description devices are designated as a client and a server for illustration purposes only. The techniques of the present invention may be performed by peers in a network, and/or by any computer systems that exchange AAA protocol messages.

Embodiments are described herein according to the following outline:
1.0 General Overview
2.0 Structural Overview
3.0 Method for Securely Extending Protected Networks Through Secure Relay of AAA Information
   3.1 AAA Message Relay Approach—Overview
   3.2 Details of Approach Using EAPOL Policy Relay Messages
   3.3 Approach for Provisioning Strong Credentials
4.0 Implementation Mechanisms-Hardware Overview
5.0 Extensions and Alternatives
   1.0 General Overview

The needs identified in the foregoing Background, and other needs and objects that will become apparent for the following description, are achieved in the present invention, which comprises, in one aspect, a method for extending a protected network through secure relay of AAA information, when the isolated device lacks Layer 3 connectivity to an AAA infrastructure of the protected network, comprises receiving a first authentication message, from an isolated first network device, wherein the first authentication message is encapsulated in a first Layer 2 message, wherein the first authentication message seeks to authenticate a second network device using an authentication server, and wherein the second network device and the authentication server are within a protected network; extracting the first authentication message from the first Layer 2 message; forming a packet that includes the first authentication message; sending the packet with the extracted authentication message over a Layer 3 link to the authentication server, without modifying the extracted authentication message. Thus a network node within a protected network can relay AAA requests and responses between an isolated AAA client, encapsulated in Layer 2 messages, and an AAA server, in Layer 3 messages.

According to one feature of this aspect, the method further comprises the second network device authenticating the isolated first network device using a challenge-response protocol. In another feature, the isolated first network device is a Fibre Channel switch that is attempting to join a secure Fibre Channel switch fabric of which the second network device is already a part. Yet another feature provides the secure relay of authentication, authorization or accounting information to and from the AAA infrastructure. In one embodiment, such secure relay comprises receiving a second authentication message from the authentication server over the Layer 3 link; forming a second Layer 2 message that encapsulates the second authentication message; and sending the second Layer 2 message to the first isolated network device.

In still another feature, the Layer 2 message is an extensible authentication protocol (EAP) over local area network (LAN) (EAPOL) message. In yet another feature, the EAPOL message comprises: a code field indicating any one of a request and a response; and a data field comprising a network address of the authentication server, and the first authentication message. The authentication messages may be RADIUS or TACACS+protocol messages.

According to another aspect, a method practiced at an isolated first network device comprises initiating a process of authenticating a second network device; determining that Layer 3 connectivity to an authentication server is unavailable; creating a first authentication message to the second network device, wherein the first authentication message is encapsulated in a first Layer 2 message, wherein the first authentication message seeks to authenticate the second network device using an authentication server, and wherein the second network device and the authentication server are within a protected network; and sending the first Layer 2 message to the second network device over a Layer 2 link. Other features that may be practiced in various embodiments of this aspect are described herein and recited in the appended claims.

In other aspects, the invention encompasses a computer apparatus and a computer-readable medium configured to carry out the foregoing steps.

2.0 Structural and Functional Overview

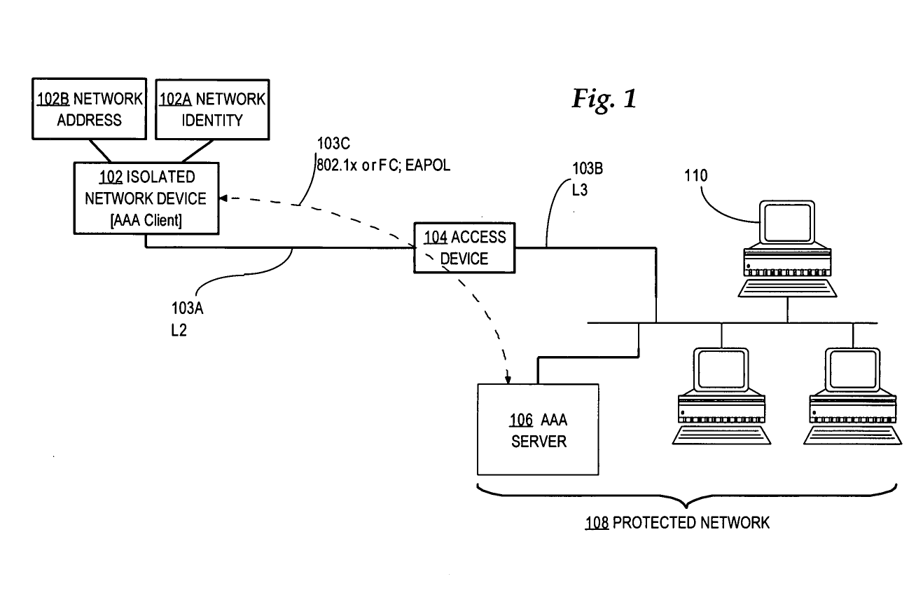

FIG. 1 is a block diagram that illustrates a high-level overview of a system in which an embodiment may be implemented. An isolated network device 102 is communicatively coupled to access device 104 by a Layer 2 link 103A. Device 102 is termed “isolated” because it has not been admitted to a protected network 108. Access device 104 is coupled by a Layer 3 link 103B to the protected network 108 that includes one or more protected end stations 110. Device 104 is denoted an “access” device because it facilitates admitting isolated network device 102 to the protected network 108; however, device 104 need not be an edge device and need not be configured as an access server. Network 108 also includes an Authentication, Authorization, and Accounting server 106 that can perform AAA functions for AAA clients.

In this description, “Layer 2” and “Layer 3” refer to logical layers in the seven-layer Open Systems Interconnection (OSI) model of network architecture.

Isolated network device 102 is any element embodying a combination of software and hardware that can perform functions useful to an end user, such as routing packets, receiving input from a user, obtaining data or services from protected end stations 110, or rendering data to the user. Isolated network device 102 may be any device that can request services from network elements in protected network 108. Examples of such devices include, but are not limited to, computer hosts using dial-up clients or VPN clients, Local Area Network (LAN) clients, and/or Wide Area Network (WAN) clients to connect to protected network 108, and mobile telephone devices where protected network 108 is a wireless telephone network. Further, in one embodiment, device 102 is a network infrastructure element such as a router, switch, or other node.

Isolated network device 102 has a network identity 102A. In one embodiment, network identity 102A is a network access identifier (NAI) value. After admission to protected network 108 through the techniques herein, isolated network device 102 also eventually may acquire a network address 102B, such as an IP address. Network address 102B also may refer more broadly to other device identifiers that are closely coupled to device 102, such as a MAC address. The specific value used for network address 102B is not critical; what is important is that device 102 has a network identity 102A that is independent of its network address.

Access device 104 is communicatively connected to AAA server 106 through protected network 108. According to the techniques herein, access device 104 acts as a relay for an AAA client hosted in isolated network device 102. In this arrangement, isolated network device 102 can act as AAA client to the AAA server 106 and authenticate the access device 104, even though the isolated device does not have Layer 3 connectivity to protected network 108 or the AAA infrastructure. In the arrangement of FIG. 1, access device 104 is already part of the protected network 108 and has secure access to the AAA server 106, for example, over UDP/IP. Isolated network device 102 is isolated or part of a network that does not offer access to AAA services. Access device 104 provides a secure relay for AAA requests that are generated by the isolated device 102. Access device 104 relays such requests to the AAA server 106 over UDP/IP transport using the techniques herein. Thus, isolated network device 102 can indirectly communicate with AAA server 106, as indicated by virtual link 103C, by sending Layer 2 EAPOL messages on link 103A over 802.1× or Fibre Channel protocols to access device 104, which converts the messages to Layer 3 messages and communicates them to the AAA server on link 103B.

Protected end stations 110 comprise one or more workstations, servers, or other network elements, which provide data or services to clients that are authenticated and authorized to access resources in the network 108.

For clarity, FIG. 1 shows one isolated network device 102 and access device 104. However, an actual implementation may have any number of such elements. In one embodiment, device 102 is, in turn, the access device for a protected network that has been deployed as an independent authentication and authorization domain. If a trust relationship exists between the AAA domains of the two networks, the approach herein allows the two devices used to connect the protected networks to securely obtain AAA services from the other domain, thereby enabling a secure and effective merge of the two protected networks. Further, protected network 108 may include multiple AAA servers 106 for load-balancing purposes or for serving different administrative domains. Protected network 108 may have any number of protected end stations 110.

Access device 104 acts as an access point to protected network 108 by maintaining one or more connections with each isolated network device 102. In some embodiments, Access device 104 runs on a remote access server that accepts access requests from one or more isolated devices 102, relays the access requests to one or more AAA servers 106 for authentication, and returns the AAA server responses to the isolated devices. Access device 104 may comprise a router located at the edge of protected network 108. Access device 104 may also comprise a software or hardware firewall that is responsible for secure routing of traffic to the network. In other embodiments, access device 104 is implemented in a mobile communications server that accepts requests from wireless devices, such as cellular telephones, and provides access to a telephone network. In some embodiments, access device 104 may be hosted on an end station device, and may be configured to receive authentication information from a user and to send access requests to AAA server 106.

Access device 104 is responsible for communicating with isolated network device 102 using a Layer 2 protocol, such as EAPOL over 802.1× or Fibre Channel, and for communicating with AAA server 106 over one or more AAA protocols at Layer 3, such as RADIUS or TACACS+. AAA server 106 provides authentication, authorization, and accounting services to users and devices that request access to protected network 108. In different embodiments, AAA server 106 may be a computer host or a specialized software or hardware component that includes one or more sequences of instructions capable of performing the foregoing tasks. Further, the techniques herein may be implemented using a computer host or a specialized software or hardware component that includes one or more sequences of instructions capable of performing the functions described herein.

3.0 Method of Securing AAA Protocol Messages

3.1 AAA Message Relay Approach—Overview

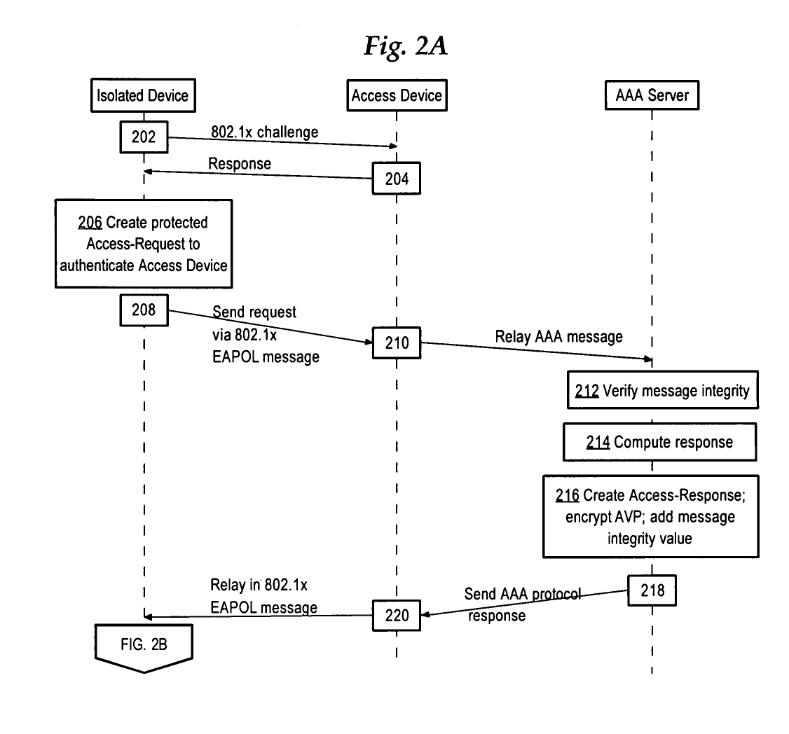

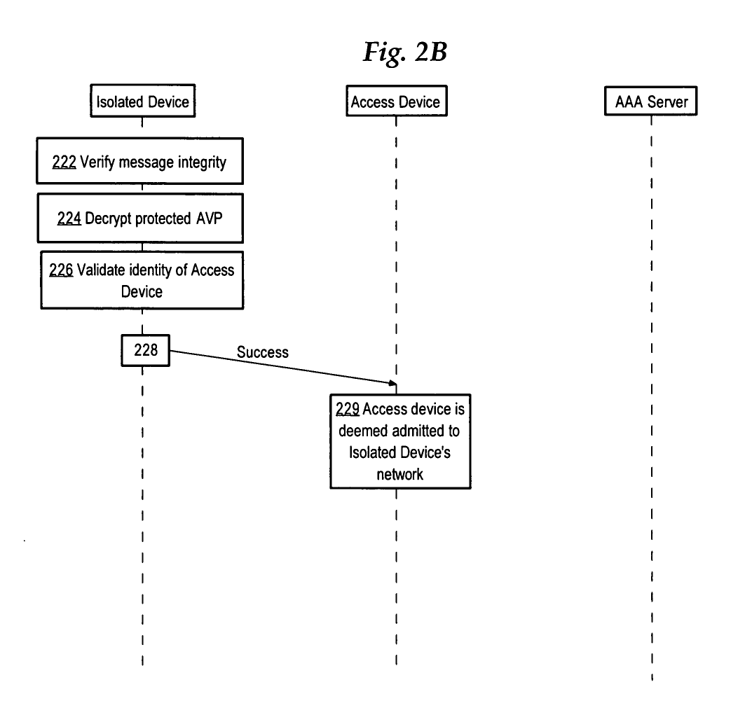

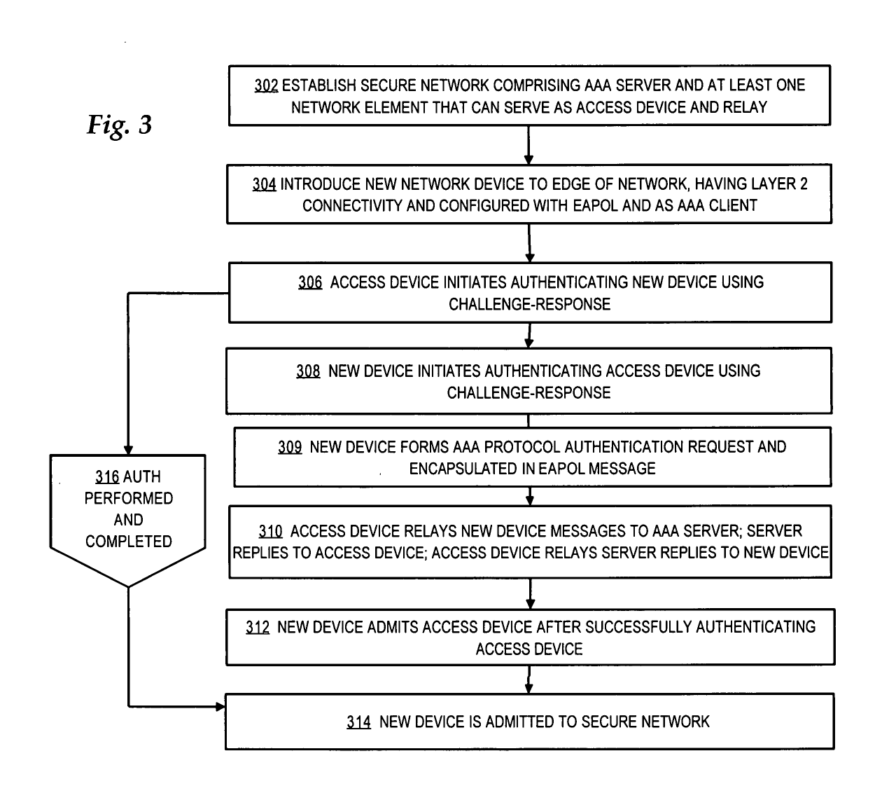

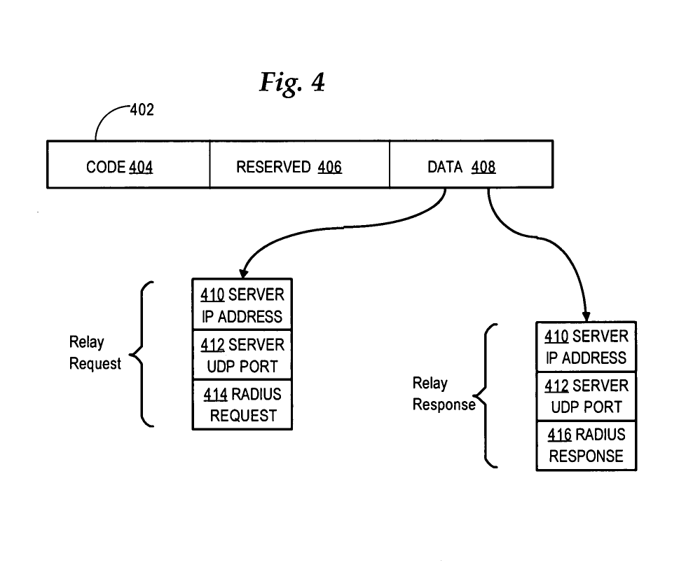

FIG. 2A is a ladder message diagram showing one example embodiment of a method of communicating authentication information; FIG. 2B is a ladder message diagram showing further steps in the method of FIG. 2A; FIG. 3 is a flow diagram showing a high-level view of one embodiment of a method of communicating authentication information; and FIG. 4 is a block diagram of an EAPOL policy relay message. For purposes of illustrating a simple example, FIG. 2A-FIG. 4 are described in the context of FIG. 1. However, the approaches herein may be practiced in many other embodiments and contexts and are not limited to the particular network system of FIG. 1. Further, the description herein refers to RADIUS protocol in certain instances purely for convenience and for illustrating a clear example. Other embodiments may use TACACS+ or any other AAA protocol.

FIG. 3 is now described for purposes of providing an overview of an approach of one embodiment. In step 302, a secure network is established, comprising an AAA server and at least one network element that can serve as an access device and relay. For example, in the context of FIG. 1, protected network 108 is deployed and access device 104 is configured as a relay, for isolated device 102 or other devices that host AAA clients, in communication with a RADIUS server, such as AAA server 106.

In step 304, a new network device is introduced to the edge of the secure network. The new network device has Layer 2 connectivity, but not Layer 3 connectivity, and is configured with EAPOL and as an AAA client. As an example, in the context of FIG. 1, isolated network device 102 may be a wireless laptop computer that is associated to a wireless access point (AP), and step 304 may involve the AP automatically contacting access device 104 to request network access. Alternatively, step 304 may involve placing a new router into service in a secure network that already includes access device 104. In still another alternative, step 304 may involve introducing a Fibre Channel switch into a secure Fibre Channel switch fabric that already includes at least one other switch in the form of access device 104.

At step 306, the access device initiates authenticating the isolated device using a challenge-response mechanism and the available AAA infrastructure. For example, in the context of FIG. 1, access device 104 may initiate an 802.1x challenge-response authentication protocol (CHAP) message sequence, and may authenticate isolated network device 102 by sending RADIUS requests to AAA server 106. Because access device 104 is in the protected network 108 and has Layer 3 access to AAA server 106, this procedure is straightforward. Upon the conclusion of the message sequence, access device 104 has authenticated isolated network device 102. As indicated by block 316, the authentication initiated at step 306 may be performed simultaneously with a separate authentication session represented by steps 308, 309, 310, 312, which are described next.

In step 308, the new device, such as isolated network device 102, initiates a process of authenticating the access device by using a challenge-response mechanism. However, because the isolated network device 102 is not within the protected network 108 and does not have Layer 3 access to AAA server 106, the isolated device cannot use conventional means to authenticate the access device 104.

In step 309, the new device forms an AAA protocol authentication request and encapsulates the AAA message in one or more EAPOL frames. For example, as further described herein, isolated network device 102 sends RADIUS Access-Request messages and receives Access-Response messages encapsulated within Layer 2 EAPOL policy relay messages as defined herein.

In step 310, the access device relays messages of the isolated device to the AAA server; the AAA server replies to the access device; and the access device relays the replies of the server to the isolated device. The access device performs conversion to and from UDP/IP and EAPOL policy relay message formats as required, without modifying the substantive content of the messages, including the end-to-end cryptographic transforms that have been applied to the messages to provide integrity protection and partial confidentiality. Thus, any encapsulated RADIUS messages travel between the isolated AAA client and the AAA server without modification at the relay.

In step 312, the new device admits the access device after successfully authenticating the access device. At step 314, when the authentication started in step 306 completes, the new device is admitted to the secure network. The authentication of step 306, 316, and 314 can start and end earlier or later than shown. However, the isolated device and the access device are in full communication only when both authentications are complete.

3.2 Details of Approach Using EAPOL Policy Relay Messages

Referring now to FIG. 2A and FIG. 2B, details of an embodiment of a method of mutual authentication, and securely extending a protected network to include a new device are described. For purposes of illustrating a clear example, the process of FIG. 2A, FIG. 2B is described herein with reference to the specific context of FIG. 1 and FIG. 4. However, the approach of FIG. 2A, FIG. 2B also may be implemented in other contexts and embodiments. The approach of the following section describes a method that allows a non-conventional EAPOL message exchange, as shown in FIG. 3, steps 308, 309, 310, 312, to occur. A description of the details of a conventional form of EAPOL authentication, as provided in steps 306, 316, 314, is not considered necessary.

To initiate the process of FIG. 2A, an isolated network device (e.g., isolated device 102 of FIG. 1) sends an 802.1x challenge message 202 to an access device such as access device 104. The access device replies with an 802.1x challenge response 204. Alternatively, the challenge-response sequence may occur over a Fibre Channel link.

Messages 202, 204 comprise EAPOL messages that are sent over 802.1x or Fibre Channel because isolated device 102 has only Layer 2 connectivity in the network. In the 802.1x embodiment as described here, the traditional roles of supplicant and authenticator are reversed, and access device 104 plays the role of supplicant and the isolated device 102 is authenticator. However, to verify the identity of the access device, the isolated device needs to send a protected AAA message to the AAA server that is in the network that the isolated device is attempting to access. Therefore, in a sequence of messages starting at step 206, the isolated device authenticates the access device through the AAA infrastructure using a secure relay or intermediation approach with conversion of messages between Layer 2 to Layer 3 protocols.

At step 206, the isolated device creates an AAA request message, such as a protected Access-Request message under the RADIUS protocol. The request message may comprise any substantive content; the request message may comprise an authentication request, or a request for any other AAA service. The message may be protected or secured by a strong credential that is shared between the device acting as AAA client, such as isolated network device 102, and the AAA server. The strong credential may be previously provisioned to the AAA client using the approaches described in Section 3.3 hereof. The use of a protected AAA request message is normally appropriate to prevent interception of information in the request, but use of a protected or secured message is not strictly required in an embodiment.

At step 208, the request message is encapsulated and sent in an 802.1x EAPOL message. According to one embodiment, the request message of step 208 is sent in an EAPOL policy relay message having the format conceived by the inventors hereof and shown in FIG. 4. Referring now to FIG. 4, an EAPOL policy relay message 402 has a packet body field that comprises a code field 404, a reserved field 406, and a data field 408. In one embodiment, a policy relay message has EAPOL type “157” (decimal). The code field 404 carries a code value indicating whether the message is a request or response; for example, code values “0” and “1” may indicate a request and response, respectively.

Data field 408 carries variable content according to whether a request or response is carried in the relay message 402. For an embodiment using UDP/IP and RADIUS, a relay message 402 comprising a request has a data field 408 comprising a server IP address value 410 for the AAA server receiving the request, a server UDP port value 412, and a RADIUS request field 414. The RADIUS request field 414 carries a complete RADIUS packet including fields or values for RADIUS type, ID, length, authenticator and attributes. A relay message comprising a response also carries a server IP address and UDP port value, and a RADIUS response 416, in the data field 408. The RADIUS response is a complete RADIUS packet. An isolated network device typically is pre-provisioned with the IP address and UDP port values.

At step 210, the access device relays the message to the AAA server. In relaying the message, the access device extracts the AAA request message from the EAPOL Policy Request message, converts the AAA request message to a conventional AAA protocol message such as a RADIUS or TACACS+ message, and sends the converted message to the AAA server over an available Layer 3 transport, such as an UDP/IP transport. The extracting and converting steps are performed so that the access device can send a Layer 3 message to the AAA server. As a result, the AAA server does not require reprogramming or modification to interoperate with the approaches herein.

The relayed message may comprise an IP packet that bears a destination address that is set to the server IP address and UDP port obtained from the EAPOL message. The source IP address may be that of the access device that is relaying the message. The access device does not modify the AAA packet or message in any way. The AAA message exchange between the isolated device and the AAA server may be secured using the isolated device's PAC key as described in Section 3.3 below, and not using a conventional credential such as a RADIUS shared secret associated with the access device's network address. The access device has no access to the isolated device's PAC key and would not be able to re-compute a message authenticator field if the access device modified the packet.

At step 212, the AAA server verifies integrity of the received request message using the strong credentials that are shared with the AAA client. In one embodiment, the AAA verifies message integrity by computing a message authentication code (MAC) and comparing the computed MAC to a MAC carried in the request message. The request message has integrity if the MAC comparison succeeds.

At step 214, the AAA server computes a response message. At step 216, the AAA server creates a response message, such as a RADIUS Access-Response, encrypts one or more elements of the response message, and adds a message integrity value. The response is authenticated using the message integrity value, and may be partially encrypted to provide confidentiality for sensitive payload values (AVPs). For example, encrypting message elements enables the AAA server to send proof-of-identity information to the isolated device over a non-secure communication channel. However, encryption is not strictly required in an embodiment. The encryption may be based upon the credentials that are shared between the AAA server and the AAA client. In some embodiments, the strong credential is a device name and PAC key that is transported in a PAC opaque payload element in all secured AAA messages. Such an identity-credential pair is independent of any network addresses (e.g., IP addresses) assigned to the AAA client.

At step 218, the AAA server sends the response message to the access device over the Layer 3 transport.

At step 220, the access device relays the message to the isolated device. In relaying the message, the access device converts the response message to an EAPOL Policy Request message from a conventional AAA protocol message, and sends the converted message to the isolated device. The converting step is performed so that the access device can send a Layer 2 message to the isolated device, which does not yet have Layer 3 connectivity in the network. In both the relaying steps 210, 220, the access device 104 does not modify substantive content of the AAA message.

The isolated device 102 can now verify the integrity of the AAA message, decrypt the protected message elements and consume the AAA message that validates the identity of the access device 104. Validation may be provided, for example, by including in the AAA response message a hash value computed using a shared secret, which is derived on each side from the strong credential that is shared between the isolated device and the AAA server.

Referring now to FIG. 2B, at step 222 the isolated device verifies the integrity of the received response message, for example, by computing a message authentication code and comparing the computed MAC to the message integrity value in the received response message. The isolated device decrypts any protected message elements at step 224, and validates the identity of the access device at step 226. Assuming the identity of the access device is validated, at step 228 the isolated device sends a success message to the access device. As shown in step 229, at that point the access device is deemed admitted to the isolated device's network. In this context, the isolated device's network may comprise only the isolated device, or a cluster of devices, such as two or more secure clouds that are joined together.

The steps described above can be repeated as many times as necessary to transport all the authentication or authorization information that the isolated device 102 requires. Thereafter, other steps may be performed by other elements to furnish the isolated device with Layer 3 connectivity in the network. For example, the isolated device can contact a dynamic host control protocol (DHCP) server in the network to obtain a dynamically assigned network address.

If access device 104 is a multi-linked device, it may be asked to relay AAA requests for multiple peers at the same time. In this arrangement, it is impossible to guarantee that the RADIUS IDs in these requests are unique across multiple peers. To prevent the AAA server from determining that request carrying a non-unique ID is a re-transmitted request, the access device 104 may use a different UDP source port value to relay requests from each peer. The UDP port stays open until the associated link is authorized and the relay service is no longer needed.

In other embodiments the method can be used to securely relay authorization information from the AAA service to the isolated device, meant to enforce access control policies, or other security policies.

In other embodiments the method can be used to securely relay accounting information from the isolated device to the AAA infrastructure, for the purpose of monitoring and/or account for events and activities that involve the isolated device. In one embodiment the method can be used to monitor attempts from un-authorized access device to impersonate a protected network.

The approaches herein may be used to provide secure AAA services to isolated network devices that are attempting to be admitted to a network but only have connectivity to a neighbor device across a Layer 2 or virtual Layer 2 link, such as an Ethernet link, Fibre Channel link, IP tunnel of any kind, etc. In one embodiment, the approach herein provides a relay service between Fibre Channel-2 transport and UDP/IP transport, for Fibre Channel entities that are forming a secure fabric.

The approaches herein may leverage security methods that provide security to AAA messages independently from the network address assigned to an AAA client. For example, an embodiment may use the approaches disclosed in co-pending application Ser. No. NNN, filed DDD, entitled “METHOD AND APPARATUS To SECURE AAA PROTOCOL MESSAGES,” of inventors Fabio Maino et al., attorney docket number 50325-0971. In such an embodiment, an AAA message may be secured with credentials that are bound to a unique identity (e.g., NAI) of the sender, and the AAA message may carry protected cryptographic material required to authenticate and decrypt the message at its destination.

Embodiments may be used with network devices that are authenticating one another and are granting network access control only to those devices that are authorized by the AAA infrastructure. In one specific embodiment, a Fibre Channel entity wishes to join a secure fabric through a Fibre Channel link connected to another entity, such as a Fibre Channel switch, that is already part of the secure fabric. In another embodiment, a network device wishes to join a secure network where authentication and authorization are handled by an AAA infrastructure; the AAA messages are communicated over UDP/IP.

Embodiments may be integrated into MACsec security approaches under IEEE 802.1ae and 802.1af, as well as the INCITS T11 Fibre Channel Security Protocols (FC-SP). Embodiments can support DH_CHAP RADIUS-based authentication for Fibre Channel.

In any of the preceding embodiments, messages communicated between the isolated network device and the authentication server may be secured end-to-end by a strong shared secret. In one embodiment, the shared secret is tied to the client device's identity rather than to the source IP address on the IP packet arriving at the server. A shared secret that is based on client device identity makes the relay approach herein possible and also differentiates the present approach from RADIUS proxies as used in past approaches.

3.3 Approach for Provisioning Strong Credentials

Provisioning network devices with strong cryptographic credentials used to enable authentication, integrity and confidentiality is a problem that has affected computer networks since their origin. Provisioning is even more complicated when it is used to provide authentication credentials for access control to networks, and is applied to devices that are introduced for the first time into a network. A first complication is introduced by the fact that higher layer transport protocols might not yet been enabled at provisioning time. Additional complexity is due to the fact that the credentials that are being provisioned are, in fact, those that should be used to secure the communication with the provisioning device.

This often leads to deployments of networks where the provisioning process is over-simplified, introducing security holes or using weak credentials that undermine the security of the entire network. The ultimate strength of network security mechanisms, in fact, relies on the strength of the provisioning process.

A classic example is the security of the RADIUS protocol. The lack of a robust provisioning procedure leads to deployments where the RADIUS security mechanisms are in practice annihilated by the use of weak credentials. For example, often the same key is shared across the entire network.

The approach herein provides a method and apparatus for the provisioning of strong credentials to network devices that are introduced for the first time, without pre-configuration, into a network. The method doesn't require a device to have full (unsecured) connectivity with the network, but only the limited capability to transport few provisioning messages over the link connected to the device already part of the network.

The method doesn't require a pre-provisioning of credential on the device, but allows for a network administrator to authenticate himself to the provisioning server on behalf of the device under provisioning, and initiate the protected credential exchange. The method provides credentials that can be used to secure communications with other network entities for the purpose of control the access of other devices to a network such as, in one embodiment, a RADIUS server.

In one embodiment an apparatus comprises an AAA server that supports the EAP-FAST fast protocol or other variants of the PEAP protocol. The apparatus includes also a device that communicates with the AAA server over an unsecured Layer 3 link, or that communicates to the AAA server through the 802.1x over EAPOL protocol with a device that is already part of the network and that can relay EAP messages over RADIUS to the AAA server.

The AAA server acts as a provisioning server, and when a new device needs to be entered into a network an entry is inserted in the AAA database with the device identity and a one-time password that is communicated to the network operator that will install the device into the network. In another embodiment the provisioning phase is authenticated with the regular password associated with the administrator identity, and already associated with the SNMPv3 User Security Model (USM).

The device to be provisioned is then attached to any of the network devices already part of the network, and a PEAP exchange over 802.1x over EAPOL is initiated during the link-up exchange. The PEAP exchange is relayed over RADIUS to the AAA server where it is terminated. This effectively provides a protected TLS channel between the provisioning server and the provisioned device. The network operator verifies the fingerprint of the public key used by the AAA server to set-up the PEAP TLS channel to authenticate the provisioning server.

A challenge-response password based authentication protocol is then initiated in the protected inner PEAP tunnel, and the operator is asked for the device identity and the one-time password associated with the device. In one embodiment MSCHAPv2 can be used, while in another embodiment the one time password method described in RFC 2289 is used.

The provisioning server verifies the challenge, authenticates the network operator and generates a new strong credential for the device under provisioning. In one embodiment this credential is a large random number, in another one is a private/public key pair.

The strong credential is provisioned to the device through the secured EAP TLS channel, and the device generates a request for updating the one-time password with a freshly generated device password that will be sent to the AAA server and used, in conjunction with the strong device credential, to authenticate the device to the AAA server.

At this point the device is fully provisioned with strong credentials that will be used as security credentials for multiple purposes. In one embodiment the credentials are used to derive keys that are used to authenticate further PEAP exchanges with the AAA server, to protect the integrity and the origin authentication of RADIUS messages, and to secure SNMPv3 messages between any pair of network devices that have access to the AAA server.

In another embodiment the one-time provisioning password based authentication, is replaced by a manufacturing certificate, securely embedded in the device at the manufacturing facility, and the first provisioning of the device can be completely automated without the need for a network operator sitting at the device under provisioning. Authentication of the device is in fact provided by the manufacturing certificate, and authentication of the AAA provisioning server is provided by cross certifying the provisioning CA within the manufacturer PKI.

The provisioning method does not require direct connectivity with one device already part of the network, but can be used also to provision devices that have unsecured layer 3 connections with the AAA server. In one embodiment unsecured RADIUS (a layer 3 protocol) is in fact used as transport protocol for the provisioning process. All RADIUS messages subsequent to the provisioning process are secured with a key derived from the provisioned credentials, providing an effective bootstrap method for RADIUS security.

In another embodiment this method is used to provision RADIUS and SNMPv3 credentials to Fibre Channel devices. In this embodiment the PEAP conversation is carried over an ILS frame as an extension of the AUTH protocol, and then proxied over UDP/IP on an IP interface connected to the AAA server.

This approach provides a secure and effective way to provision network devices with strong credentials (symmetric, asymmetric or both) that are used for device-to-device authentication through an AAA infrastructure, as well as to derive keys used to secure the AAA protocol itself, management protocols such as SNMPv3 or other network protocols.

The method leverages already existing capabilities of the AAA server, and allows for provisioning of devices either over Layer 2 Ethernet links, as well as over RADIUS over layer 3 UDP/IP. The method is also an effective way to bootstrap RADIUS security (from an insecure RADIUS connection), and in general can be used to provision credentials for other network protocols such as SNMPv3. The method integrates the credentials used for different purposes in a network: access control, AAA protections, and management security. The method allows for the use of administrator (one-time) passwords as provisioning credential, while allows also for the use of manufacturing certificates.

4.0 Implementation Mechanisms—Hardware Overview

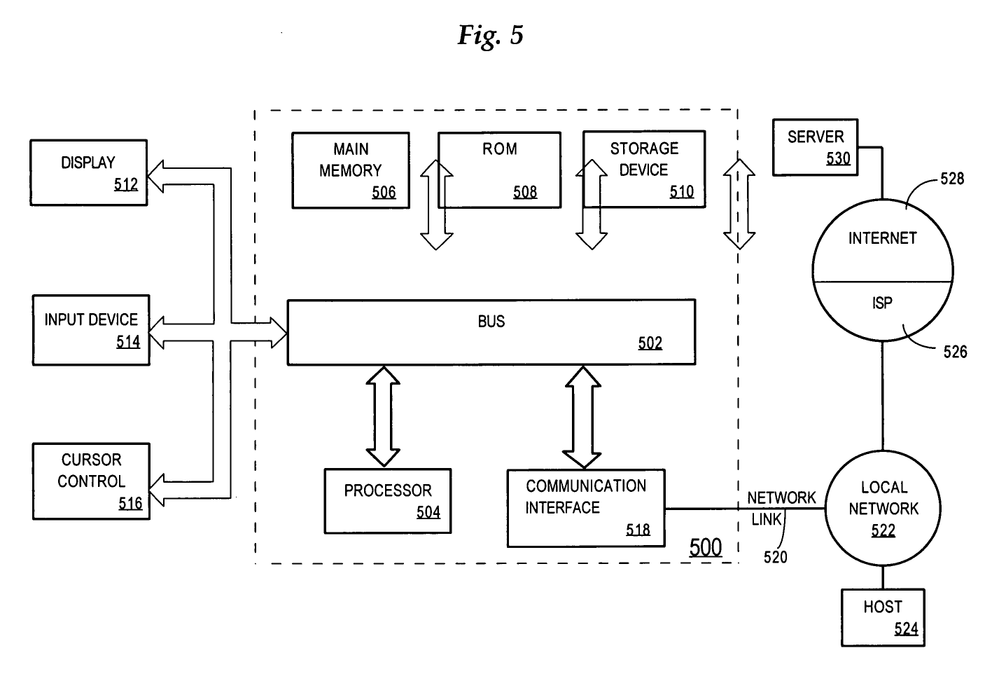

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (“RAM”) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (“ROM”) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (“CRT”), for displaying information to a computer user. An input device 514, including alphanumeric and other keys, is coupled to bus 502 for communicating information and command selections to processor 504. Another type of user input device is cursor control 516, such as a mouse, trackball, stylus, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for securing AAA protocol messages. According to one embodiment of the invention, securing AAA protocol messages is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (“ISDN”) card or a modem to provide a data communication connection to a corresponding type of telephone line. As another example, communication interface 518 may be a local area network (“LAN”) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (“ISP”) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for securing AAA protocol messages as described herein.

The received code may be executed by processor 504 as it is received, and/or stored in storage device 510, or other non-volatile storage for later execution. In this manner, computer system 500 may obtain application code in the form of a carrier wave.

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method, comprising the computer-implemented steps of:
receiving a first authentication message, from an isolated first network device, wherein the first authentication message is encapsulated in a first Layer 2 message, wherein the first authentication message seeks to authenticate a second network device using an authentication server, and wherein the second network device and the authentication server are within a protected network;
extracting the first authentication message from the first Layer 2 message;
forming a packet that includes the first authentication message;
sending the packet with the extracted authentication message over a Layer 3 link to the authentication server, without modifying the extracted authentication message.

2. A method as recited in claim 1, further comprising the second network device authenticating the isolated first network device using a challenge-response protocol.

3. A method as recited in claim 1, wherein the isolated first network device is a Fibre Channel switch that is attempting to join a secure Fibre Channel switch fabric of which the second network device is already a part.

4. A method as recited in claim 1, further comprising:
receiving a second authentication message from the authentication server over the Layer 3 link;
forming a second Layer 2 message that encapsulates the second authentication message; and
sending the second Layer 2 message to the first isolated network device.

5. A method as recited in claim 1, wherein the Layer 2 message is an extensible authentication protocol (EAP) over local area network (LAN) (EAPOL) message.

6. A method as recited in claim 5, wherein the EAPOL message comprises: a code field indicating any one of a request and a response; and a data field comprising a network address of the authentication server, and the first authentication message.

7. A method as recited in claim 6, wherein the first authentication message is a RADIUS protocol message.

8. A method as recited in claim 1, wherein the first authentication message is a RADIUS protocol message.

9. A method, comprising the computer-implemented steps of:
at a first network device, initiating a process of authenticating a second network device;
determining that Layer 3 connectivity to an authentication server is unavailable;
creating a first authentication message to the second network device, wherein the first authentication message is encapsulated in a first Layer 2 message, wherein the first authentication message seeks to authenticate the second network device using an authentication server, and wherein the second network device and the authentication server are within a protected network; and
sending the first Layer 2 message to the second network device over a Layer 2 link.

10. A method as recited in claim 9, further comprising:
receiving a second Layer 2 message from the second network device, wherein the second Layer 2 message encapsulates a second authentication message from the authentication server;
extracting the second authentication message from the second Layer 2 message; and
consuming the second authentication message as part of authenticating the second network device.

11. A method as recited in claim 9, further comprising the second network device authenticating the isolated first network device using a challenge-response protocol.

12. A method as recited in claim 9, wherein the first network device is a Fibre Channel switch that is attempting to join a secure Fibre Channel switch fabric of which the second network device is already a part.

13. A method as recited in claim 9, wherein the first Layer 2 message is an extensible authentication protocol (EAP) over local area network (LAN) (EAPOL) message.

14. A method as recited in claim 13, wherein the EAPOL message comprises: a code field indicating any one of a request and a response; and a data field comprising a network address of the authentication server, and the first authentication message.

15. A method as recited in claim 14, wherein the first authentication message is a RADIUS protocol message.

16. A method as recited in claim 9, wherein the first authentication message is a RADIUS protocol message.

17. An apparatus, comprising:
means for receiving a first authentication message, from an isolated first network device, wherein the first authentication message is encapsulated in a first Layer 2 message, wherein the first authentication message seeks to authenticate a second network device using an authentication server, and wherein the second network device and the authentication server are within a protected network;
means for extracting the first authentication message from the first Layer 2 message;
means for forming a packet that includes the first authentication message;
means for sending the packet with the extracted authentication message over a Layer 3 link to the authentication server, without modifying the extracted authentication message.

18. An apparatus, comprising:
one or more processors;
a computer-readable medium that is communicatively coupled to the one or more processors, wherein the computer-readable medium comprises one or more sequences of instructions which, when executed, cause the one or more processors to perform:
receiving a first authentication message, from an isolated first network device, wherein the first authentication message is encapsulated in a first Layer 2 message, wherein the first authentication message seeks to authenticate a second network device using an authentication server, and wherein the second network device and the authentication server are within a protected network;
extracting the first authentication message from the first Layer 2 message;
forming a packet that includes the first authentication message;
sending the packet with the extracted authentication message over a Layer 3 link to the authentication server, without modifying the extracted authentication message.

19. A computer-readable medium comprising one or more sequences of instructions which, when executed, cause one or more processors to perform:
receiving a first authentication message, from an isolated first network device, wherein the first authentication message is encapsulated in a first Layer 2 message, wherein the first authentication message seeks to authenticate a second network device using an authentication server, and wherein the second network device and the authentication server are within a protected network;
extracting the first authentication message from the first Layer 2 message;
forming a packet that includes the first authentication message;
sending the packet with the extracted authentication message over a Layer 3 link to the authentication server, without modifying the extracted authentication message.

20. A method as recited in claim 1, wherein the first network device is located within a first protected network, wherein the authentication server is located within a second protected network, and wherein the first protected network and second protected network are configured as independent authentication and authorization domains.

21. A method as recited in claim 1, wherein the messages securely relay authorization information from the authentication server to the isolated device for enforcement of access control policies or other security policies.

22. A method as recited in claim 1, wherein the messages securely relay accounting information from the isolated device to the authentication server for monitoring or accounting for events and activities that involve the isolated device.

23. A method as recited in claim 22, wherein the messages monitor attempts from an unauthorized access device to impersonate a protected network.

24. A method as recited in claim 1, wherein the second network device is any of a router acting as a relay node, a router not acting as a relay node, a switch, an access device, and the authentication server.

25. A method as recited in claim 1, wherein messages communicated between the isolated first network device and the authentication server are secured using a shared secret, wherein the shared secret is based on an identity value associated with the isolated first network device.
